(19) United States
(12) Patent Application Publication
(10) Pub. No.: US 2019/0036260 A1
(43) Pub. Date: Jan. 31, 2019

(54) RADIAL CONTACT SOCKET

(71) Applicant: Amphenol Tuchel Electronics GmbH, Heilbronn (DE)

(72) Inventors: Dawid Szymura, Ilsfeld (DE); Christian Ungerer, Untergruppenbach-Unterheinriet (DE)

(21) Appl. No.: 16/069,368

(22) PCT Filed: Dec. 13, 2016
(86) PCT No.: PCT/EP2016/080853

§ 371 Date: Jul. 11, 2018

(30) Foreign Application Priority Data
Jan. 12, 2016 (DE) 20 2016 100 095.5

(51) Int. Cl. H01R 13/187; H01R 13/11

(52) U.S. Cl. CPC H01R 13/187; H01R 13/111

(57) ABSTRACT

The invention relates to an electric plug connector socket (1) comprising a cylindrical socket sleeve (2), wherein the socket sleeve (2) is formed with a receiving space (20) in which a cylindrical lamination cage (3) having a multiplicity of contact laminations (31) running in parallel is pushed, wherein the lamination cage (3) has a first and second end-side encircling collar web (32a, 32b), between which the contact laminations (31) run, characterized in that the lamination cage (3) is clamped and/or fastened at the one (first) end at least axially and preferably also non-rotatably in the socket sleeve (2), and an axial and rotatable plain bearing in relation to the socket sleeve (2) is provided at the other (second) opposite end.

The invention relates to an electrical plug-connector socket which is configured as a radial contact socket and has a plurality of longitudinal contact elements for making contact with a corresponding plug pin and also has a sleeve which surrounds the longitudinal contact elements.

The present invention further relates to a method for producing an electrical plug-connector socket formed with a plurality of longitudinal contact elements for making contact with a corresponding plug and having a socket sleeve which surrounds the longitudinal contact elements.

US 2002/0187686 A1 discloses a socket having a T-shaped connection and also the manufacture of a lamella contact, comprising a lamella cage and a rolled contact holder which can be turned in the form of an “hourglass” in a complex manner and with the aid of various tools.

Similarly, U.S. Pat. No. 4,657,335 describes a socket which is formed by a relative rotational movement of the ends of a lamella cage into a sleeve. Rings are placed one over the other at the respective ends of the sleeve in order to secure the lamella cage in the sleeve.

US 2003/0068931 A1 discloses an electrical plug-connector socket comprising a substantially cylindrical socket sleeve which is provided with recesses at its end-side ends in order to fasten a hyperbolically rotated lamella cage, with its connection tongues, to or in said recesses.

DE 10 2011 105 821 B4 further discloses an electrical plug-connector socket having a cylindrical socket sleeve, wherein the socket sleeve is formed with a receiving space in which a hyperbolically rotated lamella cage is fitted, and the socket sleeve has a first and a second end face and the lamella cage, by way of connection tongues, is connected in an interlocking manner to the socket sleeve on the first and the second end face of said socket sleeve and that apertures are made in the transition region between the socket sleeve and the connection tongue, and that at least one of the connection tongues of the lamella cage protrudes through one of the apertures.

The solutions known in the prior art all have the disadvantage that manufacture is very complicated, in particular the geometric dimensions of sleeves, end-side sleeves and lamella cages also have to be matched to one another. Manufacturing considerations lead to a tolerance field, and this creates considerable practical problems. In general, high-precision pipes have to be used since, in each case, the inner pipe of the lamella cage has to fit into the pipe shape of the surrounding sleeve and the surrounding sleeve in turn may have to be inserted into a further sleeve receptacle and have to be fastened there.

There is generally also a problem of the lamella cage twisting in the sleeve, so that holding apparatuses have to be provided between the sleeve and the lamella cage in order to firstly secure the cage in the sleeve with the ability to rotate and secondly to engage in the cage with a tool in order to twist said cage about its center axis so that the contact lamellae are constricted in the interior.

Contact systems of the kind in which a cylindrical, in particular cylindrically rolled, contact grid is fastened to the two end-side collar webs in the sleeve surrounding the contact grid and thus is clamped on both sides present a further quite considerable problem.

Therefore, in general, plug-connector sockets of the generic type comprise an inserted contact grid which is connected to the sleeve by means of complicated material joining methods (such as welding for example).

In the case of a conventional contact grid which is attached on both sides, a large number of problems occur in application since the contact system is mechanically overdetermined. As a result, increased loading occurs at the two clamping points during the plug-in process and during subsequent operation due to vibration, active forces and thermomechanical effects since the contact, in particular after the insertion of a corresponding pin, is clamped such that it cannot, as it were, avoid any of the above-mentioned forces.

The object of the present invention is therefore to overcome the abovementioned disadvantages and to manufacture a plug-connector socket in a substantially simpler and more economical manner, wherein, at the same time, the number of components is intended to be reduced but a high current-carrying capacity is still ensured under a high temperature loading, in particular at temperatures of between 150° and 170°, and in some cases has to be reliably ensured at higher temperatures.

The invention is achieved by a plug-connector socket having the features of claim 1.

The basic idea of the present invention is to not clamp the cylindrical lamella cage at both ends as in the prior art, but rather to clamp the lamella cage at least axially and further preferably also in a rotationally fixed manner at the one (first) end and to provide a “floating bearing” or an axial and rotatable sliding bearing at the other (second) end.

In a preferred refinement of the invention, it is provided that the lamella cage is fastened at its second end to the sleeve, which surrounds the lamella cage, such that it can rotate through a small angle α.

As a result, an electrical plug-connector socket comprising a cylindrical socket sleeve is provided according to the invention, wherein the socket sleeve is formed with a receiving space in which a cylindrical lamella cage having a large number of contact lamellae which run in parallel is inserted, wherein the lamella cage has a first and a second end-side circumferential collar web, the contact lamellae running between said collar webs, characterized in that the lamella cage is clamped and/or fastened at least axially and preferably also in a rotationally fixed manner in the socket sleeve at the one (first) end and an axial sliding bearing which can be rotated at least through a certain rotary angle, in relation to the socket sleeve, is provided at the other (second) opposite end.

In a preferred embodiment, the lamella cage, by way of one of its collar webs, is fastened to the inner wall of the socket sleeve by means of sleeve-side fastening means.

In a further preferred embodiment, the lamella cage, by way of its second collar web, is mounted in an axially moving and sliding manner on the inner wall of the socket sleeve.

It is further advantageous when two or more window-like recesses or openings, each with a length L as viewed in axial direction A, are provided on the first collar web, convex portions which are respectively provided on the inner wall of the socket sleeve and have a respectively virtually identical length L′ engaging into said recesses or openings, so that axial movement of this collar web is prevented in this way.

It can advantageously also be provided that window-like recesses with a width B as viewed transverse to the axial direction are provided on the first collar web, convex portions which are provided on the inner wall of the socket sleeve and have an identical or a smaller width B′ engaging into said recesses. As a result, mounting is simplified and it is further ensured that a certain rotary mounting of the collar web in relation to the socket sleeve is provided, wherein the extent of the rotation depends on the size of the width differences between the width B and the width B′ that has been selected. A rotary angle distance of 2° to 4° is preferably selected, so that firstly good holding and secondly simpler mounting are ensured.

In a further advantageous refinement of the invention, the fastening means can be provided on the socket sleeve as stamped portions in the casing of the socket sleeve, wherein indentations are formed on the outer almond of the socket sleeve and projecting convex portions are formed on the inner casing of the socket sleeve. The positions of the convex portions are matched in a corresponding manner to the positions of the window-like openings.

It is further preferred when the fastening means are in the form of substantially cuboidal convex portions with in each case two opposite longitudinal side edges and in each case two opposite lateral side edges, so that there are defined stops and boundary edges for supporting one of the collar webs and the window-like recesses can be formed with a shape which corresponds thereto.

In an advantageous refinement of the lamella cage, this can have a smaller diameter in its central middle section as viewed in axial direction than the diameter at the collar webs.

A further aspect of the present invention relates to a method for producing an electrical plug-connector socket as described above, comprising the following method steps:
a. producing a contact lamella grid with two end-side collar webs having a large number of parallel contact lamellae which run between said collar webs;
b. making two or more window-like openings (at selected positions) in one of the collar webs of the contact lamella grid and transforming the contact lamella grid into a cylindrical shape,
c. providing a suitably shaped socket sleeve with a receiving space for receiving the cylindrical contact lamella grid and fitting convex portions, which protrude into the receiving space, (corresponding to the positions of the openings in step b) to the inner casing of the socket sleeve, preferably by stamping, and
d. introducing the cylindrical contact lamella grid into the receiving space in such a way that the convex portions engage in the window-like openings and secure the one collar web.

It is preferred when, in this case, the length L of the respective openings is matched to the length L′ of the respective convex portions such that the one collar web cannot move in the axial direction.

Further refinements of the invention can be gathered from the patent claims and also the figures and the associated description of the figures, wherein in the figures of the drawings the following is shown:

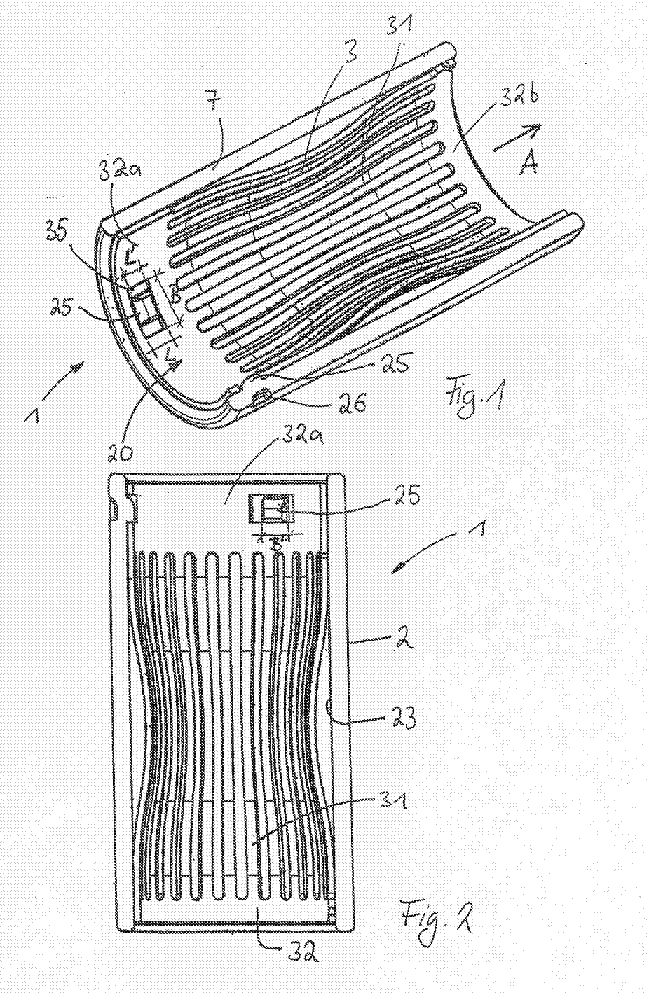

The invention will be explained in more detail below with reference to the following exemplary embodiment which is illustrated in FIGS. 1 and 2. In so doing, identical reference symbols indicate identical functional or structural features.

The figures illustrate a half-open side view of an electrical plug-connector socket 1 comprising a cylindrical socket sleeve 2, wherein the socket sleeve 2 is formed with a receiving space 20 in which a cylindrical lamella cage 3 having a large number of contact lamellae 31, which run in parallel, is inserted.

The cylindrical and tubular socket sleeve 2 has a casing 7 which is closed at the circumference and is open at the two ends.

The lamella cage 3 has a first and a second end-side circumferential collar web 32a, 32b, a large number of contact lamellae 31 running between said collar webs. The contact lamellae 31 run substantially parallel to one another so as to form a gap between in each case two adjacent contact lamellae 31.

The lamella cage 3 is clamped and fastened at least axially and preferably also in a rotationally fixed manner in the socket sleeve 2 at the one (first) end and an axial and rotatable sliding bearing in relation to the socket sleeve 2 is provided at the other (second) opposite end of the lamella cage 3.

As is further shown in FIGS. 1 and 2, the lamella cage 3, by way of one of its collar webs 32a, is fastened to the inner wall 23 of the socket sleeve 2 by means of fastening means 25. To this end, three fastening means 25 are provided in the circumferential direction.

Furthermore, the lamella cage 3, by way of its second collar web 32b, is mounted in an axially moving and sliding manner on the inner wall 23 of the socket sleeve 2 and therefore not clamped, as intended. During the insertion process with an insertion pin, not illustrated, the contact lamellae 31 are deformed in the radial direction since the lamella cage 3 has a constriction in its middle central section and accordingly has a smaller diameter. To this end, the contact pin has a larger diameter than the lamella cage 3 in its middle central section. The one-sided sliding bearing of the collar web 32b allows axial movement of said collar web. Since the deflection is reversible, the lamella cage 3 returns to its original shape as soon as the contact pin has been removed again. The same relative movement is made possible in the event of vibrations, under thermomechanical heating etc., so that plastic deformation and weakening of the contact system are avoided.

Three window-like recesses or openings 35 are provided on the first collar web 32a, one said window-like recess or opening being shown in the views of FIGS. 1 and 2. The openings are each provided with a length L as viewed in the axial direction A, the convex portions 25 of a respectively virtually identical length L′, which convex portions are respectively provided on the inner wall 23 of the socket sleeve 2, engaging into said openings, so that axial movement of this collar web 32a is prevented in this way.

The window-like recesses 35 on the first collar web 32a are further formed with a width B as viewed transverse to the axial direction A, the convex portions 25 of a smaller width B′ engaging in said recesses.

Furthermore, indentations 26 are formed on the outer almond 24 of the socket sleeve 2 and projecting convex portions 25 are formed in the casing 7 opposite said indentations.

The implementation of the invention is not restricted to the preferred exemplary embodiments described above. Rather, a number of variants are feasible which make use of the illustrated solution even for embodiments of a fundamentally different nature.

1. An electrical plug-connector socket comprising:
a cylindrical socket sleeve that has first and second opposite ends and a receiving space in which a cylindrical lamella cage having a number of contact lamellae which run in parallel is inserted, wherein the lamella cage has a first and a second end-side circumferential collar web, the contact lamellae running between said collar webs,
wherein the lamella cage is fastened at least axially and in a rotationally fixed manner in the socket sleeve at the first end and an axial and rotatable sliding bearing in relation to the socket sleeve is provided at the second end.

2. The electrical plug-connector socket as claimed in claim 1, wherein the lamella cage, by way of one of the collar webs, is fastened to an inner wall of the socket sleeve.

3. The electrical plug-connector socket as claimed in claim 1, wherein the lamella cage, by way of the second collar web, is mounted in an axially moving and sliding manner on an inner wall of the socket sleeve.

4. The electrical plug-connector socket as claimed in claim 1, wherein two or more window-like recesses or openings, each with a length as viewed in an axial direction, are provided on the first collar web, convex portions which are respectively provided on an inner wall of the socket sleeve and have a respectively substantially identical length engaging into said recesses or openings, so that axial movement of this the first collar web is prevented.

5. The electrical plug-connector socket as claimed in claim 1, wherein window-like recesses or recesses with a width as viewed transverse to an axial direction are provided on the first collar web, convex portions which are provided on an inner wall of the socket sleeve and have an identical or a smaller width engaging into said recesses or openings.

6. The electrical plug-connector socket as claimed in claim 2, wherein fastening means are provided on the socket sleeve as stamped portions in a casing of the socket sleeve, wherein indentations are formed on an outer almond of the socket sleeve and projecting convex portions are formed on the inner wall casing of the socket sleeve.

7. The electrical plug-connector socket as claimed in claim 6, wherein the fastening means are in the form of substantially cuboidal convex portions with in each case two opposite longitudinal side edges and in each case two opposite lateral side edges.

8. The electrical plug-connector socket as claimed in claim 1, wherein the lamella cage has a smaller diameter in a central middle section thereof as viewed in an axial direction than at the collar webs.
